(19) United States
(12) Patent Application Publication
(10) Pub. No.: US 2017/0090238 A1
(43) Pub. Date: Mar. 30, 2017

(54) SHELL FRAME AND MANUFACTURING METHOD THEREOF

(71) Applicant: Shenzhen China Star Optoelectronics Technology Co., Ltd., Shenzhen, Guangdong (CN)

(72) Inventor: Peng DU, Shenzhen, Guangdong (CN)

(73) Assignee: Shenzhen China Star Optoelectronics Technology Co., Ltd., Shenzhen, Guangdong (CN)

(21) Appl. No.: 14/787,588

(22) PCT Filed: May 8, 2015
(86) PCT No.: PCT/CN2015/078546

§ 371 Date: Oct. 28, 2015

(30) Foreign Application Priority Data
Apr. 29, 2015 (CN) 201510209697.8

(51) Int. Cl. G02F 1/1333; B05D 5/06; B05D 7/00

(52) U.S. Cl. CPC G02F 1/133308; B05D 7/50; B05D 5/06; G02F 2001/13332

(57) ABSTRACT

The invention provides a shell frame and a manufacturing method thereof. The shell frame includes: a substrate; at least one ink layer coated on the substrate and each being mixed with particles containing a color dye; and at least one cured layer, each of the at least one ink layer being coated with one cured layer, the outmost cured layer having concave and convex shapes to thereby exhibit different colors and patterns at different viewing angles. When the shell frame is pressed, the color dye in the particles is released to make the shell frame exhibit different patterns according to different pressed situations. By the above solution, the invention is capable of making the shell frame transform the pattern along with different angles and thereby achieving visual impact and tactile effect.

### TECHNICAL FIELD

The invention relates to the field of liquid crystal display, and particularly to a shell frame and a manufacturing method thereof.

### DESCRIPTION OF RELATED ART

A conventional electronic apparatus generally has a single color coated shell frame, and a soft-touch coating process is applied to the shell frame, e.g., black, white, colorless and so on. Such shell frame can exhibit a certain texture by the change of refractive index according to a viewing angle. During a manufacturing process, two types of materials are individually deposited. The first deposited material has a certain refractive index and is formed by a mixture of at least two types selected from SiO2 (silicon dioxide), TiO2 (titanium dioxide), Al2O3 (aluminum oxide) and so on. The second deposited material has a refractive index different from that of the first deposited material, but also is formed by a mixture of at least two types selected from SiO2, TiO2, Al2O3 and so on. Of course, the deposition can be achieved by alternately depositing two types of materials many times instead. However, the conventional coated shell frame does not provide too much visual even tactile impact, except can provide a ceramic pearl texture by reproducing brightness and color anisotropy according to a viewing angle of user.

### SUMMARY

Accordingly, a technical problem mainly to be solved by the invention is to provide a shell frame and a manufacturing method thereof, which can transform the pattern along with different angles and thereby achieve visual impact and tactile effect.

In order to solve the above technical problem, a technical solution proposed by the invention is to provide a shell frame. The shell frame includes: a substrate; at least one ink layer coated on the substrate, wherein the at least one ink layer each is mixed with particles containing a color dye; and at least one cured layer, wherein each of the at least one ink layer is coated with one of the at least one cured layer, the outmost cured layer has concave and convex shapes to thereby exhibit different colors and patterns at different viewing angles. When the shell frame is pressed, the color dye in the particles is released to make the shell frame exhibit different patterns depend upon different pressed situations. The particles includes at least one selected from the group consisting of a copper and aluminum metal particles mixture, a TiO2/Fe2O3 and mica powders mixture, and copper and aluminum metal particles coated with a layer of polymer. The polymer is any one of polyethylene, polypropylene and polystyrene. The particles and coating material of the at least one ink layer have a significant refractive index difference.

In one embodiment, a cross section of the outmost cured layer is saw-toothed or circular arc-shaped.

In one embodiment, the shell frame includes a plurality of the ink layers, the plurality of ink layers are added with different particles and have different colors.

In order to solve the above technical problem, another technical solution provided by the invention is to provide a shell frame. The shell frame includes: a substrate; at least one ink layer coated on the substrate, wherein the at least one ink layer each is mixed with particles containing a color dye; and at least one cured layer, wherein each of the at least one ink layer is coated with one of the at least one cured layer, the outmost cured layer has concave and convex shapes to thereby exhibit different colors and patterns at different viewing angles. When the shell frame is pressed, the color dye contained in the particles is released to make the shell frame exhibit different patterns according to different pressed situations.

In one embodiment, the particles include at least one selected from the group consisting of a mixture of copper and aluminum metal particles, a mixture of TiO2/Fe2O3 and mica powders, and copper and aluminum metal particles coated with a layer of polymer; the polymer is any one of polyethylene, polypropylene and polystyrene.

In one embodiment, the particles and coating material of the at least one ink layer have a significant difference of refractive index.

In one embodiment, a cross section of the outmost cured layer is saw-toothed or circular arc-shaped.

In one embodiment, the shell frame includes a plurality of the ink layers, the plurality of ink layers are mixed with different particles and have different colors.

In one embodiment, the at least one cured layer is cured by UV light irradiation.

In one embodiment, the at least one cured layer is cured by chemical crosslinking a two-component material after being mixed.

In order to solve the above technical problem, another technical solution provided by the invention is to provide a manufacturing method of a shell frame. The manufacturing method includes: coating at least one ink layer on a substrate, wherein each of the at least one ink layer is mixed with particles containing a color dye; and coating each of the at least one ink layer with a cured layer, wherein the outmost cured layer has concave and convex shapes to thereby exhibit different colors and patterns at different viewing angles. When the shell frame is pressed, the color dye contained in the particles is released to make the shell frame exhibit different patterns according to different pressed situations.

In one embodiment, the particles include at least one selected from the group consisting of a mixture of copper and aluminum metal particles, a mixture of TiO2/Fe2O3 and mica powders, and copper and aluminum metal particles coated with a layer of polymer; the polymer is any one of polyethylene, polypropylene and polystyrene.

In one embodiment, the particles and coating material of the at least one ink layer have a significant refractive index difference.

In one embodiment, a cross section of the outmost cured layer is saw-toothed or circular arc-shaped.

In one embodiment, the shell frame includes a plurality of the ink layers, the plurality of ink layers are mixed with different particles and have different colors.

Sum up, the efficacy can be achieved by the invention is that: distinguished from the prior art, the shell frame of the invention includes a substrate, at least one ink layer coated on the substrate and each being mixed with particles containing a color dye, and at least one cured layer; each ink layer is coated with one cured layer, and the outmost cured layer has concave and convex shapes to thereby exhibit different colors and patterns at different viewing angles; when the shell frame is pressed, the color dye in the particles is released, different patterns would be exhibited according to different pressed situations, so that the shell frame can transform the pattern along with different angles and thus can achieve visual impact and tactile effect.

### BRIEF DESCRIPTION OF THE DRAWINGS

FIG. 1 is a schematic structural view of a shell frame according to a first embodiment of the invention;

FIG. 2 is a light path diagram of the shell frame in FIG. 1;

FIG. 3 is a schematic structural view of a shell frame according to a second embodiment of the invention;

FIG. 4 is a schematic structural view of a shell frame according to a third embodiment of the invention; and

FIG. 5 is a flowchart of a manufacturing method of a shell frame according to an embodiment of the invention.

### DETAILED DESCRIPTION OF EMBODIMENTS

Referring to FIG. 1, FIG. 1 is a schematic structural view of a shell frame according to a first embodiment of the invention. As illustrated in FIG. 1, the shell frame 10 includes: a substrate 11, at least one ink layer 12 and at least one cured layer 14. The at least one ink layer 12 is coated on the substrate 11, and the illustrated ink layer 12 is mixed with particles 13 containing a color dye. The at least one cured layer 14 each is coated on one ink layer 12, and the outmost cured layer 14 has concave and convex shapes to thereby exhibit different colors and patterns at different viewing angles. When the shell frame 10 is pressed, the color dye contained in the particles 13 would be released, so as to make the shell frame exhibit different patterns according to different pressed situations.

In an embodiment of the invention, the particles 13 include at least one selected from the group consisting of a copper and aluminum metal particles mixture, a TiO2/Fe2O3 and mica powder mixture, and copper and aluminum metal particles coated with a layer of polymer. The polymer may be any one of polyethylene, polypropylene and polystyrene. The particles 13 and coating material of the ink layer have a significant refractive index difference.

In an embodiment of the invention, a major ingredient of the cured layer 14 may be acrylate resin, polyurethane resin and so on. The cured layer 14 may be cured by UV light irradiation or by chemical crosslinking a two-component material after being mixed. After the outmost cured layer 14 is coated, concave and convex stereoscopic shapes can be formed on a surface thereof by a corresponding mold, so that different colors and patterns can be exhibited at different viewing angles of user. In addition, in different pressed situations, different patterns also can be exhibited. Specifically, the outmost cured layer 14 is formed with a saw-toothed surface by a mold, i.e., a cross section of the outmost cured layer 14 is saw-toothed, so that at different viewing angles of the user, different colors and patterns can be exhibited. As illustrated in FIG. 3, the outmost cured layer 24 also may be circular arc-shaped instead, so that the appearance of the shell frame 20 can exhibit more abundant changes along with the change of observation angle.

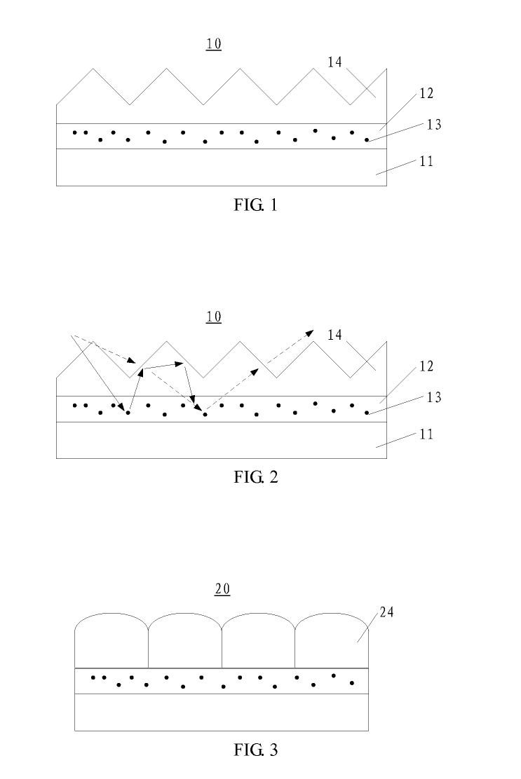

A light path of the shell frame 10 is illustrated in FIG. 2. Since refractive indexes of different particles and ink have a difference, reflection directions to an incident light are caused to be different, the saw-toothed surface only allow light rays concentrated in a certain direction to be emitted out, as illustrated in the light path diagram. At different observation angles, scatterings produced by the particles at different directions to the incident light can be observed. A specific pattern only can be observed in a certain angle, while it is unobservable in other angles, i.e., is hidden away. Therefore, the shell frame can transform the pattern along with different angles and thus can achieve visual impact and tactile effect.

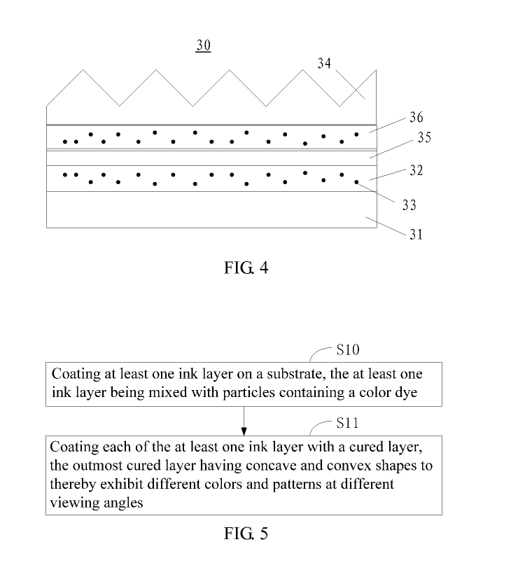

In an embodiment of the invention, the shell frame may include multiple (i.e., more than one) ink layers, different ink layers are added/mixed with different particles and have different colors. Each ink layer is coated with a cured layer, i.e., each adjacent two ink layers is separated by one cured layer. The numbers/amounts of the ink layers and cured layers are determined according to actual situations and thus are not limited herein. As illustrated in FIG. 4, the shell frame 30 includes an ink layer 33 and another ink layer 36, the ink layer 33 and the ink layer 36 are coated with a cured layer 34 and another cured layer 35 respectively. A cross section of the outmost cured layer 34 is saw-toothed, as shown in FIG. 4; or, the cross section may be circular arc-shaped instead, as illustrated in FIG. 3. Since the existence of multiple ink layers, when the shell frame is observed, it can exhibit a visual effect of being similar to pearl texture. If multiple layers of coating material are used, light rays would be reflected many times, including specular reflection and diffuse reflection, they would interfere with each other and thereby produce the luster similar to the pearl texture.

FIG. 5 is a flowchart of a manufacturing method of a shell frame according to an embodiment of the invention. As illustrated in FIG. 5, the manufacturing method of a shell frame includes:

Step S10: coating at least one ink layer on a substrate, the at least one ink layer each being mixed with particulars containing a color dye.

The particles includes at least one selected from the group consisting of a copper and aluminum metal particles mixture, a TiO2/Fe2O3 and mica powders mixture, and copper and aluminum metal particles coated with a layer of polymer. The polymer may be any one of polyethylene, polypropylene and polystyrene. The particles and coating material of the ink layer have a significant refractive index difference.

Step S11: coating each of the at least one ink layer with a cured layer, the outmost cured layer having concave and convex shapes to thereby exhibit different colors and patterns at different viewing angles.

When the shell frame is pressed, the color dye in the particles would be released so as to exhibit different patterns according to different pressed situations.

In an embodiment of the invention, a major ingredient of each cured layer may be acrylate resin, polyurethane resin and so on. Each the cured layer may be cured by UV light irradiation or by chemical crosslinking a two-component material after being mixed. The outmost cured layer after being coated can be formed with concave and convex stereoscopic shapes on a surface thereof by a corresponding mold, so that the user can observe different colors and patterns at different viewing angles, and in addition, different pressed situations also can produce different patterns. In particular, the outmost cured layer is formed with a saw-toothed surface by a mold, i.e., a cross section of the cured layer is saw-toothed, which makes the user can observe different colors and patterns at different viewing angles. Since different particles and ink have a refractive index difference, reflection directions to an incident light are caused to be different, the saw-toothed surface only allow light rays concentrated in a certain direction to be emitted out. At different viewing angles, scatterings produced by the particles to the incident light at different directions can be observed. A specific pattern only can be observed in a certain angle, but it is unobservable in other angles, i.e., is hidden away. Therefore, the shell frame can transform the pattern along with different angles and thus can achieve visual impact and tactile effect.

The outmost cured layer also may be circular arc-shaped instead, so that the appearance of the shell frame can exhibit more abundant changes along with the change of viewing angle, please refer to FIG. 3.

In an embodiment of the invention, multiple ink layers may be coated on the substrate, and different ink layers are added with different particles and have different colors. Each ink layer is coated with a cured layer, i.e., each two adjacent ink layers are spaced from each other by one cured layer. The numbers/amounts of the ink layers and the cured layers can be determined according to actual situations, and thus are not limited herein. A cross section of the outmost cured layer is saw-toothed or circular arc-shaped. Owing to the existence of multiple ink layers, when the shell frame is observed, it can exhibit visual effect of being similar to pearl texture. If multiple layers of coating material are used, light rays would be reflected many times, including specular reflection and diffuse reflection, they would interfere with each other and thus produce the luster being similar to the pearl texture.

In summary, the shell frame of the invention includes: a substrate, at least one ink layer coated on the substrate and each being mixed with particles containing a color dye, and at least one cured layer. Each of the at least one ink layer is coated with one cured layer thereon, the outmost cured layer has concave and convex shapes, so that different colors and patterns can be exhibited at different viewing angles. When the shell frame is pressed, the color dye contained in the particles is released and thus different patterns can be exhibited according to different pressed situations. As a result, the shell frame can transform the pattern along with different angles and thereby can achieve visual impact and tactile effect.

The foregoing discussion only is some embodiments of the invention, but it is not to limit the patent scope of the invention, any equivalent structures or equivalent processes made according to the specification and the accompanying drawings of the invention, or directly or indirectly being used in other related technical fields, should be included within the patent protection scope of the invention.

What is claimed is:

1. A shell frame comprising:
a substrate;
at least one ink layer coated on the substrate, wherein the at least one ink layer is mixed with particles containing a color dye;
at least one cured layer, wherein each of the at least one ink layer is coated with one of the at least one cured layer, the outmost cured layer has concave and convex shapes to thereby exhibit different colors and patterns at different viewing angles;
wherein when the shell frame is pressed, the color dye in the particles is released to make the shell frame exhibit different patterns depend upon different pressed situations, the particles comprise at least one selected from the group consisting of a copper and aluminum metal particles mixture, a TiO2/Fe2O3 and mica powders mixture, and copper and aluminum metal particles coated with a layer of polymer, the polymer is any one of polyethylene, polypropylene and polystyrene, the particles and coating material of the at least one ink layer have a significant refractive index difference.

2. The shell frame as claimed in claim 1, wherein a cross section of the outmost cured layer is saw-toothed or circular arc-shaped.

3. The shell frame as claimed in claim 1, wherein the shell frame comprises a plurality of the ink layers, the plurality of ink layers are mixed with different particles and have different colors.

4. A shell frame comprising:
a substrate;
at least one ink layer coated on the substrate, wherein the at least one ink layer each is mixed with particles containing a color dye;
at least one cured layer, wherein each of the at least one ink layer is coated with one of the at least one cured layer, the outmost cured layer has concave and convex shapes to thereby exhibit different colors and patterns at different viewing angles;
wherein when the shell frame is pressed, the color dye contained in the particles is released to make the shell frame exhibit different patterns according to different pressed situations.

5. The shell frame as claimed in claim 4, wherein the particles comprise at least one selected from the group consisting of a mixture of copper and aluminum metal particles, a mixture of TiO2/Fe2O3 and mica powders, and copper and aluminum metal particles coated with a layer of polymer; the polymer is any one of polyethylene, polypropylene and polystyrene.

6. The shell frame as claimed in claim 4, wherein the particles and coating material of the at least one ink layer have a significant difference of refractive index.

7. The shell frame as claimed in claim 4, wherein a cross section of the outmost cured layer is saw-toothed or circular arc-shaped.

8. The shell frame as claimed in claim 4, wherein the shell frame comprises a plurality of the ink layers, the plurality of ink layers are mixed with different particles and have different colors.

9. The shell frame as claimed in claim 4, wherein the at least one cured layer is cured by UV light irradiation.

10. The shell frame as claimed in claim 4, wherein the at least one cured layer is cured by chemical crosslinking a two-component material after being mixed.

11. A manufacturing method of a shell frame, comprising:
coating at least one ink layer on a substrate, wherein each of the at least one ink layer is mixed with particles containing a color dye;
coating each of the at least one ink layer with a cured layer, wherein the outmost cured layer has concave and convex shapes to thereby exhibit different colors and patterns at different viewing angles;
wherein when the shell frame is pressed, the color dye contained in the particles is released to make the shell frame exhibit different patterns according to different pressed situations.

12. The manufacturing method as claimed in claim 11, wherein the particles comprise at least one selected from the group consisting of a mixture of copper and aluminum metal particles, a mixture of TiO2/Fe2O3 and mica powders, and copper and aluminum metal particles coated with a layer of polymer; the polymer is any one of polyethylene, polypropylene and polystyrene.

13. The manufacturing method as claimed in claim 11, wherein the particles and coating material of the at least one ink layer have a significant refractive index difference.

14. The manufacturing method as claimed in claim 11, wherein a cross section of the outmost cured layer is saw-toothed or circular arc-shaped.

15. The manufacturing method as claimed in claim 11, wherein the shell frame comprises a plurality of the ink layers, the plurality of ink layers are mixed with different particles and have different colors.
